(19) United States
(12) Patent Application Publication
(10) Pub. No.: US 2011/0075439 A1
(43) Pub. Date: Mar. 31, 2011

(54) LIGHTING AND/OR SIGNALLING DEVICE FOR A MOTOR VEHICLE COMPRISING A VENTILATION DUCT

(75) Inventors: Christophe CROS, Nanterre (FR); Christine ROUCOULES, Deuil La Barre (FR); Sébastien PETIT, Montfermeil (FR); Jean-Claude PUENTE, Livry Gargan (FR)

(73) Assignee: VALEO VISION, Bobigny Cedex (FR)

(21) Appl. No.: 12/893,064

(22) Filed: Sep. 29, 2010

(30) Foreign Application Priority Data
Sep. 29, 2009 (FR) 0956721

(51) Int. Cl. B60Q 1/26

(52) U.S. Cl. 362/547

(57) ABSTRACT

A lighting and/or signalling device for a motor vehicle, comprising an enclosure which is formed by a housing and glass, an opening being provided in the enclosure, wherein it comprises a ventilation duct which extends from the opening, the ventilation duct being closed by a filtering means which is impermeable to fluids and dust, and permeable to gases.

### CROSS-REFERENCE TO RELATED APPLICATIONS

This application is related to French Application No. 0956721 filed Sep. 29, 2009, which application is incorporated herein by reference and made a part hereof.

### BACKGROUND OF THE INVENTION

1. Field of the Invention

The present invention relates to a lighting and/or signalling device for a motor vehicle. It also relates to a vehicle which is equipped with a lighting and/or signalling device of this type.

2. Description of the Related Art

It is known to ventilate the lighting and/or signalling devices for motor vehicles. In fact, this ventilation makes it possible to balance the pressure of the gases between the interior and the exterior of the lighting and/or signalling device. In fact, in operation, the lighting and/or signalling devices heat up, and the gases which they contain would be compressed in the absence of ventilation. The ventilation therefore permits the expansion of the gases.

The presence of ventilation poses a problem of intake of humidity into the lighting and/or signalling devices, and consequently a problem of condensation. This problem of condensation is encountered mainly in hot engine compartments of motor vehicles which have lighting and/or signalling devices, the sources of light of which emit considerable heat, in particular halogen lamps or xenon lamps, as well as so-called “cold light” sources of light, such as LED sources, the semiconductor element of which emits far less heat than the halogen or xenon sources. These cold sources of light have the advantage of low consumption. Depending on its form, the glass has cold areas which are all the larger, the less the sources heat the glass. In the areas where the temperature of the glass of the device is relatively cold, the risk of condensation at the level of the closure glass of the lighting and/or signalling device is high. This risk is even greater with sources of light with a semiconductor element, since although the latter heats up, the light beam for its part contains few infrared rays, and the glass is virtually unheated by the lighting in comparison with other sources, such as filament lamps. In order to eliminate the condensation, it is necessary to prevent the intake of humidity into the lighting and/or signalling device, and to assist the evaporation of the humidity.

There are various solutions for solving this problem of intake of humidity. Certain devices are ventilated with openings with baffles or labyrinth seals (as described for example in documents FR 2 738 782, which was also published as U.S. Pat. No. 5,758,957, FR 2 660 413, FR 2 639 010), or with openings which are provided with filtering membranes or fine tubes.

The solutions which use baffles or labyrinth seals have disadvantages. They have forms with limited sizes which make it possible to ventilate the headlight only in a limited area. These solutions make it possible to limit the liquid water, but are coupled to the lighting and/or signalling devices, which means that they ventilate the latter only with hot damp air taken from the engine compartment. In addition, these solutions do not make it possible to filter the dust.

The solutions with a fine tube have limited ventilation efficiency because the small cross-sections and length of the tubes generate substantial losses of load. They have the disadvantage that they do not prevent intake of water or dust.

Other devices are provided with drying systems (as described for example in document U.S. Pat. No. 6,422,729).

What is needed, therefore, is a lighting and/or signalling device comprising an improved ventilation duct.

### SUMMARY OF THE INVENTION

One object of the invention is to provide a lighting and/or signalling device for a motor vehicle which makes it possible to eliminate the problem previously described and which improves the devices known according to the prior art.

In particular, one embodiment of the invention proposes a lighting and/or signalling device for a motor vehicle which is simple, and makes it possible to assure good ventilation with cool, dry air, whilst preventing the intake of water and dust into the device.

According to one embodiment of the invention, the lighting and/or signalling device for a motor vehicle comprises an enclosure which is formed by a housing and glass, an opening being provided in the enclosure. It comprises a ventilation duct which extends from the opening, the ventilation duct being closed by a filtering means which is impermeable to fluids and dust and permeable to gases. The duct thus makes it possible to collect cool gases at a distance from the enclosure of the device, whilst preventing dust or a fluid from penetrating into the enclosure.

The length of the duct is, for example, more than 2 cm. The reference length value for the duct is, for example, 15 cm.

The filtering means can be glued in the duct or to a free end of the duct. The filtering means can also be glued at the level of an opening in the duct. The filtering means can also be a part which is over-molded between two parts of the duct, for example with a cylindrical form. Thus, the filtering means can be put into place simply.

The filtering means can be a membrane, in particular a textile membrane, for example a membrane based on PTFE (or an equivalent material), in order to guarantee the impermeability to fluids. It must also be impermeable to dust without getting blocked, in order to guarantee permeability to air throughout the service life of the vehicle.

The duct can be secured to the housing by being pinched or soldered or clipped on. These solutions permit simple implementation of the device according to the invention, whilst assuring sealing at the level of this securing.

The device can comprise a plurality of openings provided in the housing, and from each of which a ventilation duct extends. In this case, the areas of the straight sections of each of the ducts and/or the filtering means are reduced in comparison with the area of the straight section of the duct and/or the filtering means of a device according to the invention which comprises only a single duct.

The duct can comprise an anti-drip means. An anti-drip means of this type makes it possible to assure that the liquid water is not in contact with the filtering means.

According to one embodiment of the invention, the motor vehicle comprises a lighting and/or signalling device as previously defined.

Preferably, a free end of the ventilation duct is positioned at the level:

of a radiator grille of the motor vehicle, in particular at the level of a ventilation mouth of the engine compartment; or

of a wing of the motor vehicle; or

on the front surface of the lighting and/or signalling device.

At the level of these areas, there is cool, dry air, which makes it possible to ventilate the enclosure efficiently in order to discharge the humidity from it.

In particular, a free end of the ventilation duct can be positioned at the level of a location where the pressure varies according to the characteristics of travel of the motor vehicle. These variations of pressure make it possible to assist the exchanges of gas between the interior of the enclosure and the external environment.

These and other objects and advantages of the invention will be apparent from the following description, the accompanying drawings and the appended claims.

### BRIEF DESCRIPTION OF THE ACCOMPANYING DRAWINGS

The attached drawing represents by way of example an embodiment of a lighting and/or signalling device for a motor vehicle according to the invention.

FIG. 1 is a diagram of a longitudinal and vertical cross-section of an embodiment of a lighting and/or signalling device according to the invention, for a motor vehicle.

### DETAILED DESCRIPTION OF THE PREFERRED EMBODIMENTS

According to one embodiment of the invention, the lighting and/or signalling device 1 comprises an aeration or ventilation duct 10 which makes it possible to offset, away from the enclosure 9 of the device 1, the place from which the ventilation air of this enclosure 9 is taken. Thus, it is possible to use the coldest and driest air. The cross-section of the duct 10 is adapted to the length of the duct 10, in order to limit the losses of load. In addition, in order to prevent the intake of dust and water, means for filtering of the duct 10 can be added, as well as, optionally, protection against dripping of water, so as to prevent the accumulation of water on the membrane.

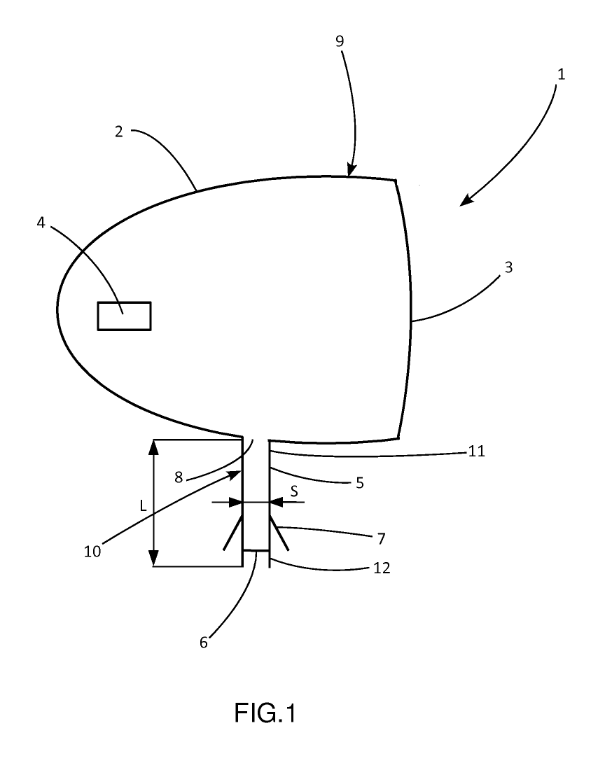

A lighting and/or signalling device 1 for a motor vehicle, represented schematically in cross-section in FIG. 1, comprises mainly an enclosure 9 and a duct 10 for aeration or ventilation of this enclosure 9.

The enclosure 9 consists mainly of a case 2, which optionally forms or contains an optical mirror and transparent closure glass 3. The enclosure 9 contains a source of light 4, such as, in particular, an electric bulb, a halogen lamp, or one or a plurality of LEDs. Apart from a passage which is formed by an opening 8 which is provided in the housing, the enclosure 9 is sealed. This opening 8 makes it possible to balance the pressure of the gases which are in the enclosure 9 of the lighting and/or signalling device 1 and in the external environment. Preferably, the opening 8 is provided in a lower part of the housing, i.e., in the base of the housing, or in the lower part of a lateral wall of the housing.

The ventilation duct 10 is connected to the housing at the level of the opening 8 by a first end 11. The ventilation duct 10 also comprises a second free end 12. The ventilation duct 10 mainly comprises a tube 5 and a filter or filtering means 6 of this tube 5. The tube 5 can be made of any material, however it is preferably made of flexible or rigid plastic material, for example of EPDM (ethylene propylene diene monomer). For example, the tube 5 has a circular cross-section, in particular a circular inner cross-section. However, it can have any other form of cross-section.

The filter or filtering means 6 is also made of any material, provided that it is impermeable to fluids and dust, and permeable to gases throughout the life of the product. It consists for example of a membrane, which is made for example of a textile material or PTFE which has these properties. The membrane is preferably glued into the tube 5, or on the tube 5. It can be over-molded with the tube 5 in a form such as to assure the largest possible exchange surface. It can be maintained on a structure in the form of a grid, which makes it possible to strengthen it in accordance with the surface area involved. The membrane can be replaced by any component which diffuses the humidity well, and prevents intake of water, dust, or any impurity. The membrane can be positioned anywhere, in particular on the tube 5, inside the tube 5, or at the end of the tube 5. Preferably, it is hoped to obtain a rate of diffusion per unit of time and per unit of surface area for the transfer of humidity which is close to 1 mm⁻²·h⁻¹. In fact, the humidity which is present in the enclosure 9 can be discharged to the external environment by diffusion through the membrane, the level of humidity at the free end of the duct 10 being lower than the level of humidity in the enclosure 9. The rate of diffusion per unit of time is a function of the surface area of the membrane and the nature of the permeability of the membrane. The gradient which characterizes the development of the rate of diffusion as a function of the surface area with the hypothesis of linear variation is between 0.001 mm⁻²·h⁻¹ and 0.01 mm⁻²·h⁻¹, with a typical value for a certain type of membrane of 0.002 mm⁻²·h⁻¹. The surface area of the membrane must therefore be adapted as a function of the type of membrane (in particular its permeability) and the rate of diffusion which it is hoped to obtain.

The dimensions of the ventilation duct 10 are determined as a function of the lighting and/or signalling device 1, and in particular as a function of the volume of the enclosure 9 of the lighting and/or signalling device 1. In addition, the area S of the straight section of the tube 5 is a function of its length L and/or of the different bends which it may have along its length. In fact, the longer the tube 5 and/or the more twisting its path is, the larger the area of the straight section of the tube 5 must be in order to limit the losses of load in the ventilation duct 10 which are of a nature such as to limit the exchanges of gas between the enclosure of the lighting and/or signalling device 1 and the external environment. Similarly, as previously explained, the area of the membrane must be designed such that it does not limit the exchanges of gas between the enclosure 9 and the external environment. Thus, the area of the membrane can be different from, and in particular larger than, the area of the straight section of the tube 5. In this case, the tube 5 can have at the level of the membrane an area of straight section which is different from the area of its straight section at another level. Alternatively or complementarily, the membrane may not be arranged according to a straight section of the tube 5, but slanting in relation to the latter, and/or it can extend according to a non-flat surface, in order to maximize the surface area of the membrane in a tube 5 with given dimensions.

For a lighting device of the headlight type, the enclosure volume of which is between 2 liters and 20 liters, the area of the inner section of the tube 5 is for example between 7 mm² and 700 mm², i.e., for a tube 5 with a circular inner cross-section, a diameter of between approximately 3 mm and 30 mm, and preferably between 38 mm² and 320 mm², i.e., for a tube 5 with a circular inner cross-section, a diameter of between approximately 7 mm and 20 mm. The area of the membrane can have the same characteristics.

For a lighting device of the anti-fog headlight type, the enclosure volume of which is less than 2 liters, the area of the inner section of the tube 5 is for example less than 80 mm², i.e., for a tube 5 with a circular inner cross-section, a diameter of less than 10 mm, and preferably between 12 mm² and 40 mm², i.e., for a tube 5 with a circular inner cross-section, a diameter of between approximately 4 mm and 7 mm. The area of the membrane can have the same characteristics.

For a signalling device of the rear lamp type, the enclosure volume of which is less than 6 liters, the area of the inner section of the tube 5 is for example less than 180 mm², i.e., for a tube 5 with a circular inner cross-section, a diameter of less than 15 mm, and preferably between 12 mm² and 80 mm², i.e., for a tube 5 with a circular inner cross-section, a diameter of between approximately 4 mm and 10 mm. The area of the membrane can have the same characteristics.

The problem of the presence of humidity, and therefore of condensation, is greater when the engine of the vehicle on which the lighting and/or signalling device 1 is installed is hot. The hot air tends to rise, and the air which is situated lower is therefore colder and drier. It therefore appears more advantageous to position the free end 12 of the tube 5 so that it is below the headlight, rather than positioning it directly in the vicinity of the enclosure 9 of the lighting and/or signalling device 1, at the level of the latter or above it. Thus, the duct 10 preferably extends vertically downwards, or substantially vertically downwards, from the enclosure 9. Preferably, the ventilation duct 10 comprises a tube 5 with a length and shape suitable for its free end 12 to be able to be positioned at the level of a wing of the motor vehicle, at the level of the radiator grille of the motor vehicle, in particular at the level of a ventilation mouth of the engine compartment, this mouth being situated at the level of the radiator grille of the motor vehicle, or on the front surface of the lighting and/or signalling device 1. On the other hand, these areas are not in the vicinity of the enclosure of the lighting and/or signalling device 1, and the tube 5 therefore has a length which is at least greater than 2 cm, and preferably greater than 15 cm (the reference value being 15 cm).

The ventilation duct 10 can have an anti-drip shield 7. This makes it possible to prevent water or other fluids from dripping along the tube 5, to the free end of the latter, where the membrane is located. This anti-drip shield 7 can be made of any material, and can be made in any form which prevents the water from dripping onto the membrane. For example, the anti-drip shield 7 can be made of plastic material, it can be secured in the lower part of the tube 5, directly on the latter, and have a form which widens downwards, in particular a frusto-conical form. If the membrane is not disposed at the free end of the tube 5, no anti-drip shield 7 is necessary: in fact, it is the free end itself of the tube 5 which, in combination with the higher position of the membrane in the tube 5, prevents the water from rising as far as the membrane.

By means of the lighting and/or signalling device 1 according to the invention, the filtering means is the only interface which permits gaseous exchanges between the enclosure 9 and the external environment.

According to a variant embodiment, the lighting and/or signalling device 1 can comprise a plurality of openings 8, to which several ventilation ducts 10 are connected.

The ventilation device constituted by the opening 8 and the ventilation ducts 10 is very simple to produce in comparison with solutions with baffles or labyrinth seals known according to the prior art.

As seen, the length of the ventilation duct 10 makes it possible to position its free end in a selected location which is designed to solve the problems previously described. In particular, it makes it possible to position the free end of the ventilation duct 10 in a location where the pressure varies as a function of the characteristics of travel of the motor vehicle. Thus, these variations of pressure make it possible to assist the gaseous exchanges between the interior of the enclosure 9 and the external environment, by means of alternation of pressure and low pressure of the external environment in relation to the interior of the enclosure 9. In the hypothesis of a level of humidity in the enclosure which is greater than the level of humidity at the level of the free end of the duct 10, these pressures and low pressures create flows of humid gases towards the exterior of the enclosure 9, and flows of dry gases towards the interior of the enclosure 9.

The tube 5 can be made in several parts. For example, it can be made of a rigid upper part which is secured at the level of the opening 8, and of a flexible lower part, which is over-molded onto the upper part, and is provided with the membrane. Alternatively, the tube 5 can be made of three parts, i.e., a flexible upper part which is secured at the level of the opening 8, a rigid intermediate part on which the upper part is over-molded, and a flexible lower part, which is over-molded on the intermediate part, and is provided with the membrane. In these two cases, the filtering medium can be secured at the level of the flexible lower part.

In the case in which the end of the duct 10 is disposed at the level of a compartment of the vehicle which is dry and only slightly dusty, for example the passenger space of the vehicle, or a particular compartment inside this passenger space, it is possible to dispense with the filtering medium.

The invention applies to different lighting and/or signalling devices, in particular a front headlight of a motor vehicle, an anti-fog headlight of a motor vehicle, and a motor vehicle signalling rear light. The lighting and/or signalling device can be a front lighting and/or signalling device, or a rear lighting and/or signalling device.

While the forms of apparatus herein described constitutes preferred embodiments of this invention, it is to be understood that the invention is not limited to these precise forms of apparatus, and that changes may be made therein without departing from the scope of the invention which is defined in the appended claims.

What is claimed is:

1. A lighting and/or signalling device for a motor vehicle, comprising an enclosure which is formed by a housing and glass, an opening being provided in the enclosure, wherein said enclosure comprises a ventilation duct which extends from the opening, the ventilation duct being closed by a filter which is impermeable to fluids and dust, and permeable to gases.

2. The lighting and/or signalling device according to claim 1, wherein the length (L) of the ventilation duct is greater than 2 cm.

3. The lighting and/or signalling device according to claim 1, wherein said filter is glued in the ventilation duct, or to a free end of the ventilation duct.

4. The lighting and/or signalling device according to claim 1, wherein said filter is a membrane, and in particular a textile membrane.

5. The lighting and/or signalling device according to claim 2, wherein the ventilation duct is secured to the housing by being pinched or soldered or clipped on.

6. The lighting and/or signalling device according to claim 1, wherein it comprises a plurality of openings which are provided in the housing, and from each of which a ventilation duct extends.

7. The lighting and/or signalling device according to claim 1, wherein the ventilation duct comprises an anti-drip means.

8. A motor vehicle comprising a lighting and/or signalling device according to claim 1.

9. The motor vehicle according to claim 8, wherein a free end of the ventilation duct is positioned at the level:
of a radiator grille of the motor vehicle, in particular at the level of a ventilation mouth of the engine compartment; or
of a wing of the motor vehicle; or
on the front surface of the lighting and/or signalling device.

10. The motor vehicle according to claim 8, wherein a free end of the ventilation duct is positioned at the level of a location where the pressure varies according to the characteristics of travel of the motor vehicle.

11. A lighting and/or signalling device for a motor vehicle, comprising an enclosure which is formed by a housing and a glass, an opening being provided in the enclosure, said lighting and/or signalling device comprising a ventilation duct which extends from the opening, the ventilation duct being closed by filtering means for filtering said enclosure which is impermeable to fluids and dust and permeable to gases, said filtering means comprising a membrane.

12. A lighting and/or signalling device for a motor vehicle comprising:
an enclosure formed by a housing and a closure;
a ventilation duct that extends from an opening in said housing; and
a filter located in said ventilation duct.

13. The lighting and/or signalling device according to claim 12, wherein the length (L) of said ventilation duct is greater than 2 cm.

14. The lighting and/or signalling device according to claim 12, wherein said filter is adhered in said ventilation duct or to a free end of said ventilation duct.

15. The lighting and/or signalling device according to claim 12, wherein said filter is a textile membrane.

16. The lighting and/or signalling device according to claim 1, wherein said ventilation duct comprises an anti-drip projection.

17. A motor vehicle comprising a lighting and/or signalling device according to claim 12.

18. The lighting and/or signalling device according to claim 12, wherein said filter is adapted as a function of the type of membrane and a predetermined rate of diffusion.

19. The lighting and/or signalling device according to claim 12, wherein said ventilation duct comprises dimensions that are determined as a function of a volume of said enclosure.

20. The lighting and/or signalling device according to claim 19, wherein said volume of said enclosure is between 2 liters and 20 liters.

21. The lighting and/or signalling device according to claim 19, wherein an area of an inner section of said enclosure is between 7 mm² and 700 mm².

22. The lighting and/or signalling device according to claim 19, wherein said volume of said enclosure is less than 2 liters.

23. The lighting and/or signalling device according to claim 19, wherein an enclosure volume is less than 6 liters, an area of the inner section of the enclosure is less than 180 mm² and comprises a circular inner cross-section.

24. The lighting and/or signalling device according to claim 12, wherein said enclosure comprises a plurality of openings to which a plurality of ventilation ducts, respectively, are connected.

25. The lighting and/or signalling device according to claim 12, wherein said ventilation duct is elongated and extends generally vertically downward with said filter being located near an end of said ventilation duct.
